(19) United States
(12) Patent Application Publication
(10) Pub. No.: US 2017/0045376 A1
(43) Pub. Date: Feb. 16, 2017

(54) MAGNETIC ELEMENT

(71) Applicant: Hartmann-exact KG, Schorndorf (DE)

(72) Inventors: Wolfgang Betz, Schorndorf (DE); Ritesh Kumar, Backnang (DE)

(21) Appl. No.: 15/232,270

(22) Filed: Aug. 9, 2016

(30) Foreign Application Priority Data
Aug. 14, 2015 (DE) 10 2015 215 578.1

(51) Int. Cl. G01D 5/14

(52) U.S. Cl. CPC G01D 5/14

(57) ABSTRACT

A magnetic element (1) has a base body (2) made of a magnetic or magnetizable material. The base body (2) has, in cross section, essentially the geometry of a rectangle (4) with a first side (3a) and a second side (3b) lying opposite the first side (3a). In cross section the first side (3a) has a first recess (5a), and the second side (3b) has a second recess (5b).

### BACKGROUND

1. Field of the Invention

The invention relates to a magnetic element and to a magnetic field sensor arrangement having such a magnetic element.

2. Description of the Related Art

Modern systems for determining the position of components for a motor vehicle relative to one another frequently use magnetic sensors which detect the fields generated by a magnetic component. A translatory or rotational movement of the magnetic component relative to the magnetic field sensor can be detected by the magnetic field sensor, and the change in position which has taken place between the magnetic element and the magnetic field sensor can be determined from the measurement of the change in the magnetic field.

An arrangement which is frequently installed in transmission devices of motor vehicles is composed of a shaft which can be adjusted in a rotatable fashion as well as translational fashion in relation to the magnetic field sensor and on which said magnetic element is attached. By using this arrangement composed of the magnetic element and magnetic field sensor it is possible to determine both the rotational position and the translational position of the shaft.

It proves disadvantageous with conventional arrangements composed of a magnetic element and magnetic field sensor that the accuracy which can be achieved with such arrangements during the determination of position often no longer satisfies the accuracy requirements in modern motor vehicles.

Against this background, it is therefore an object of the present invention to provide an improved embodiment of a magnetic element and of a magnetic field sensor arrangement having such a magnetic element and a magnetic field sensor, which embodiment is distinguished, in particular, by improved accuracy during the determination of position.

These objects are achieved according to the subject matter of the independent patent claims. Preferred embodiments are the subject matter of the dependent patent claims.

### SUMMARY

The basic idea of the invention is accordingly, in the case of a magnetic element which has the geometry of a rectangle in cross section, respectively to provide a recess in a first side of this rectangle and in a second side of the rectangle lying opposite this first side.

Experimental investigations have shown that the two recesses lying opposite one another in said cross section generate a magnetic field with a field line profile which can be measured with particularly high accuracy by a magnetic field sensor. In particular, in this context changes in magnetic field which originate from a translatory and/or rotational change in position of the magnetic element relative to the magnetic field sensor are determined with extremely high accuracy. Therefore, the magnetic element according to the invention which is presented here is particularly suitable for use in motor vehicles, in particular in a transmission, when the position of a shaft which can be adjusted in a translatory and rotational fashion is to be determined with high precision.

A magnetic element according to the invention comprises a base body made of a magnetic or magnetizable material. The base body has, in cross section, essentially the geometry of a rectangle with a first side and with a second side lying opposite the first side. According to the invention in cross section the first side has a first recess, and the second side has a second recess.

In one variant, by suitably embodying the base body in cross section it is possible also to consider, instead of a rectangle, the more general geometry of a quadrilateral with another angular arrangement of the four sides with respect to one another than in the case of a rectangle. For example, an embodiment as a trapezium is conceivable.

The cross section particularly extends parallel to a plan view of the base body, in particular of an upper side or underside of the base body. A magnetic field which can be detected particularly accurately is generated by means of geometric shaping of the base body which accompanies such an arrangement.

In one preferred embodiment, the rectangle has a third side and a fourth side lying opposite the third side. The third and fourth sides connect the first side to the second side and in this way complete the first side and the second side to form the rectangle. In this variant, a third recess is therefore present in cross section in the third side, and a fourth recess in the fourth side. In an alternative variant to this, no recesses are present either in the third side or in the fourth side.

At least one recess, preferably at least two recesses lying opposite one another, and at maximum preferably all the recesses which are present, preferably each have a round contour in cross section. Such a round contour gives rise to a particularly favourable field curve profile of the magnetic field generated by the magnetic element, for the determination of position.

In one advantageous development, at least one recess has in each case the contour of an ellipsoidal segment in cross section. This preferably applies to at least two recesses lying opposite one another, particularly preferably to all the recesses which are present.

An increased measuring accuracy when using the magnetic element in combination with a magnetic field sensor can be achieved with a further preferred embodiment in which the at least two recesses lying opposite one another are essentially embodied identically.

However, all the recesses which are present are particularly preferably embodied in identically. In this way, a particularly high measuring accuracy can be achieved.

In a further preferred embodiment which is an alternative to the embodiments explained above, at least one recess has in each case a nonround geometry in cross section, with at least one corner, preferably with at least two corners, at maximum preferably with a multiplicity of corners. Such a geometry of the recess or recesses with an angular cross section is also very well suited to highly accurate determination of a position using a magnetic field sensor which interacts with a magnetic element.

Experimental investigations have shown that a rotational or translational change in position of the magnetic element relative to the magnetic field sensor can be detected particularly precisely if a length of at least one recess, preferably of all the recesses, comprises in cross section at least a fifth, preferably at least half, particularly preferably at least three quarters, of a length of the respective side in which this recess is formed. The length of each of the four sides of the rectangle is preferably between 10 mm and 100 mm.

The length of at least one recess, preferably of all the recesses, particularly preferably comprised in a cross section of the rectangle comprises at maximum 98%, preferably at maximum 95%, particularly preferably at maximum 90% of a length of the respective side in which this recess is formed. Such a geometry also improves the accuracy of the determination of position which can be achieved in combination with a magnetic field sensor.

A further improvement in the measuring accuracy can be achieved if the rectangle is in cross section axis-symmetrically with respect to an axis of symmetry which runs parallel to the first side. The same effect can be achieved if the rectangle is embodied in cross section axis-symmetrically with respect to an axis of symmetry which runs orthogonally with respect to the first side.

A magnetic field which is particularly suitable for detection with high positional accuracy can be generated by the magnetic element presented here if the first side and the second side each connect an upper side to an underside of the base body, if the first recess in the first side extends from the upper side as far as the underside and if the second recess in the second side extends from the upper side as far as the underside. This means that both the first and the second recesses can also be recognized by a viewer in a plan view. In other words, in any desired cross section of the base body parallel to the upper side the first and second recesses are present. The same applies mutatis mutandis to the third recess which is present in the third side and/or to the fourth recess which is present in the fourth side.

The base body of the magnetic element is particularly expediently embodied in a bipolar fashion. This results in a slight change in position of the magnetic element relative to the magnetic field sensor and brings about a significant change in the magnetic field which acts on the magnetic field sensor.

The invention also relates to a magnetic field sensor arrangement having a magnetic field sensor which is arranged at a distance from the magnetic element and has the purpose of determining a magnetic field which acts on the magnetic field sensor. The magnetic field sensor arrangement also comprises a magnetic element which is presented above for generating the magnetic field which can be detected by the magnetic field sensor. The magnetic element is arranged in a rotationally fixed fashion on a shaft by means of an attachment device, a rotational axis of the magnetic field sensor arrangement being defined by the direction of longitudinal extent of said shaft. The rotational axis is preferably defined by means of a centre longitudinal axis of the shaft. The shaft is embodied here so as to be adjustable relative to the magnetic field sensor, in a rotatable fashion about said rotational axis and/or in a translational fashion in the direction of longitudinal extent. According to the invention, the rotational axis runs in the cross section of the magnetic element, parallel or orthogonal to the first side.

In one preferred embodiment, the attachment device can comprise a receptacle in which the magnetic element is at least partially accommodated. This facilitates the mounting for the magnetic element on the shaft.

Cost advantages during the manufacture are obtained with a further preferred embodiment according to which the attachment device is integrally formed on the shaft.

Further important features and advantages of the invention can be found in the dependent claims, the drawings and the associated description of the figures with reference to the drawings.

Of course, the features which are mentioned above and those which are still to be explained below can be used not only in the respectively specified combination but also in other combinations or alone without departing from the scope of the present invention.

Preferred exemplary embodiments of the invention are illustrated in the drawings and will be explained in more detail in the following description, wherein identical reference symbols relate to identical or similar or functionally identical components.

### BRIEF DESCRIPTION OF THE DRAWINGS

FIG. 1 shows a first example of a magnetic element according to the invention in a cross section parallel to a plan view of the base body of the magnetic element.

FIG. 2 shows a second example of a magnetic element according to the invention in a cross section parallel to a plan view of the base body of the magnetic element.

FIG. 3 shows the magnetic element in FIG. 1 in a perspective illustration.

FIG. 4 shows the magnetic element in FIG. 2 in a perspective illustration.

FIGS. 5 and 6 show variants of the examples in FIGS. 1 and 2.

FIGS. 7-10 show an example of the magnetic field sensor arrangement according to the invention in various views.

### DETAILED DESCRIPTION

FIG. 1 illustrates an example of a magnetic element 1 according to the invention in a cross section parallel to a plan view of a base body 2 of the magnetic element 1. The magnetic element 1 therefore comprises a base body 2 composed of a magnetic or magnetisable material which preferably has essentially the geometric shape of a rectangular solid. The base body 2 is preferably embodied in a bipolar fashion. In cross section, the base body 2 essentially has the geometry of a rectangle 4 with a first side 3a and a second side 3b lying opposite the first side 3a. The term “essentially” is to be understood here as meaning that geometries with a slight deviation from the geometry of a rectangle, for example a rectangle with one or more truncated corners, are covered by the term “rectangle”. Furthermore, the rectangle 4 has a third side 3c and fourth side 3d which lies opposite the third side 3c, both of which sides respectively connect the first side 3a and the second side 3b and in this way complete the first side 3a and the second side 3b to form the rectangle.

As is apparent from FIG. 1, in the cross section in the base body 2 there is a first recess 5a present in the first side 3a, and a second recess 5b present in the second side 3b. In contrast, there are no recesses provided in the third and fourth sides 3c, 3d.

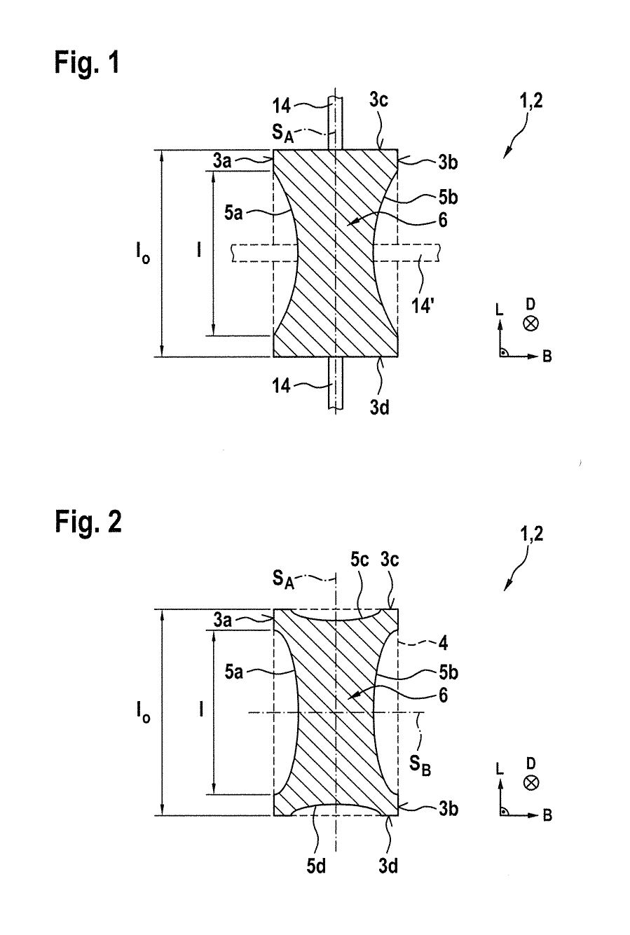

Firstly, attention is drawn to the illustration in FIG. 2 which shows a variant of the example in FIG. 1. In the example in FIG. 2, in addition to the first recess 5a in the first side 3a and in addition to the second recess 5b in the second side 3b there is also a third recess 5c in the third side 3c and a fourth recess 5d in the fourth side 3d.

In the text which follows, possible geometries or contours of the recesses 5a to 5d which can be applied both to the variant in FIG. 1 and to the variant in FIG. 2 will now be explained. In the example scenario in FIGS. 1 and 2, all the recesses 5a-5d which are present have a respective round contour. From FIGS. 1 and 2 it is apparent that the recesses 5a-5d can have in cross section the contour or geometry of an ellipsoidal segment. Such a contour profile can be implemented in at least one of the recesses 5a-5d which are present. At least two recesses 5a-5d which lie opposite one another preferably have such a contour, and particularly preferably all the recesses 5a-5d have one, as shown in FIGS. 1 and 2.

The rectangle 4 in FIGS. 1 and 2 can be embodied in cross section so as to be axis-symmetrical with respect to an axis of symmetry SA which runs parallel to the first and second sides 3a, 3b. Alternatively or additionally, the rectangle 4 can also be embodied so as to be axis-symmetrical with respect to an axis of symmetry SB which runs parallel to the third and fourth sides 3c, 3d.

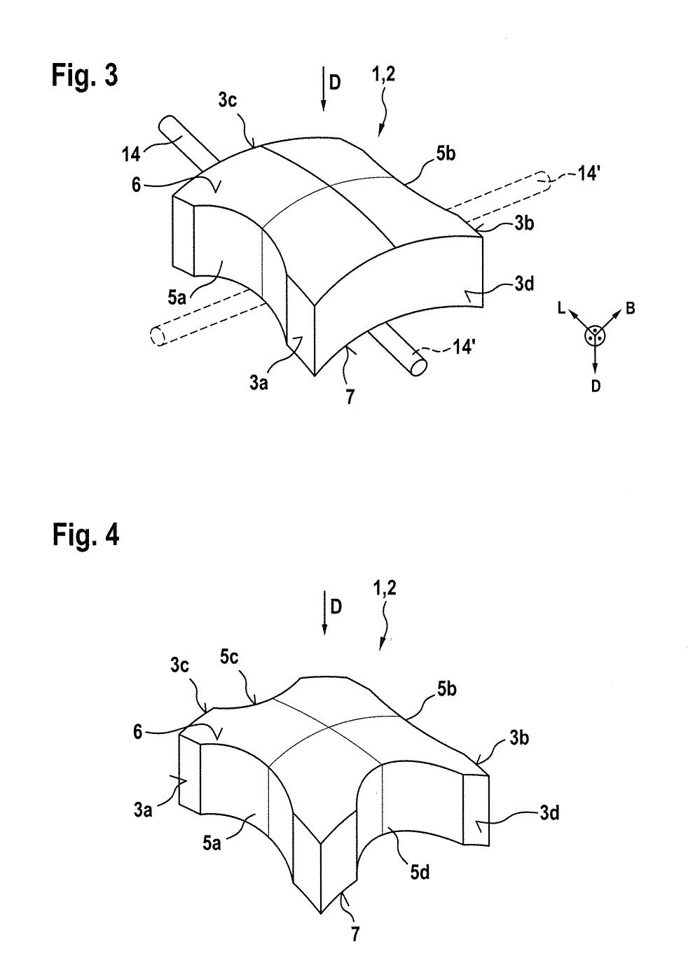

FIG. 3 then shows a perspective illustration of the magnetic element 1 in FIG. 1, and FIG. 4 shows a perspective illustration of the magnetic element 1 in FIG. 3. The cross section shown in FIGS. 1 and 2 parallel to a plan view is formed by a cross-sectional plane which extends parallel to an upper side 6 (cf. FIGS. 3 and 4) of the base body 2. The viewing direction of a viewer perpendicularly on this upper side 6 is indicated in FIGS. 1 to 4 by a direction arrow denoted by “D”. It is apparent from FIGS. 3 and 4 that the upper side 6 of the base body 2 can also be curved in the direction D, in particular convexly or concavely. The same applies to an underside 7, lying opposite the upper side 6, of the base body 2.

In the example in FIGS. 1 and 2, in each case two recesses 5a, 5b and 5c, 5d which lie opposite one another are identical, i.e. embodied with an identical geometry. This can preferably apply even to all the recesses which are present, i.e. to all four recesses 5a-5d in the example scenario (not shown in the figures).

According to FIGS. 1 and 2, a length l of a recess 5a-5d, preferably of all the recesses 5a-5d, can be at least a fifth, preferably at least half, particularly preferably at least three quarters, of a length l0 of the respective side in which these recesses 5a-5d are formed. Correspondingly, the length l of a recess 5a-5d, preferably of all the recesses 5a-5d can be at maximum 98%, preferably at maximum 95%, particularly preferably at maximum 90% of the length l0 of the respective side 3a-3d in which this recess 5a-5d is formed. In FIGS. 1 and 2, the lengths l and l0 are shown by way of example only for the first side 3a or the first recess 5a, for the sake of clarity.

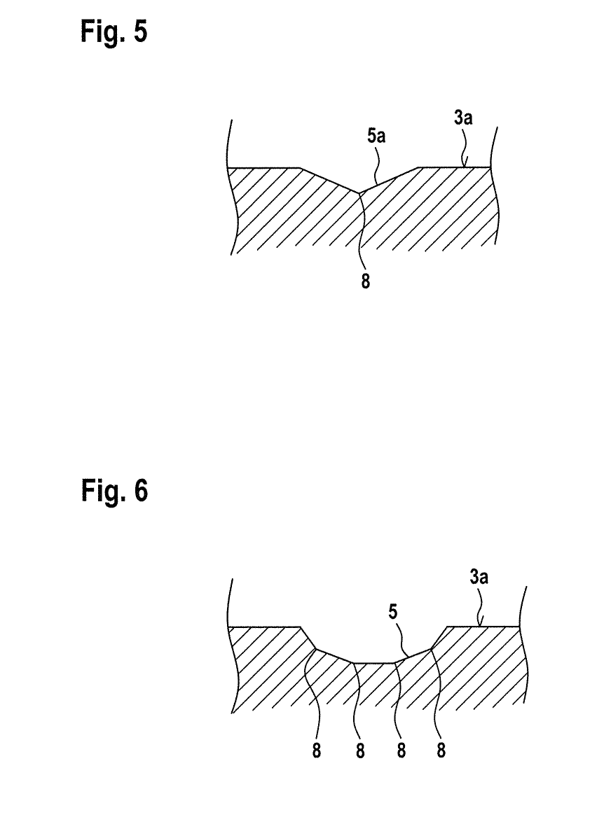

In a variant which is an alternative to the examples in FIGS. 1 to 4 and which is shown in FIGS. 5 and 6, the recesses 5a-5d can each have a non-round geometry in cross section, with at least one corner 8. FIG. 6 shows, by way of example for the first side 3a, a first recess 5a with one corner, and FIG. 6 with four corners. To a person skilled in the art it is clear that further refinement possibilities are possible with another number of corners and a different contour of the recess 5a. This also applies to the second, third and fourth recesses 5b, 5c and 5d.

In the example scenario in FIGS. 1 to 4, the first side 3a and the second side 3b each connect an upper side 6 to an underside 7 of the essentially rectangular-solid-shaped base body 2.

A magnetic field which is particularly advantageous for detection with high positional accuracy can be generated by the magnetic element 1 if the first recess 5a in the first side 3a extends from the upper side 6 as far as the underside 7, and the second recess 5b in the second side 3b extends from the upper side 6 as far as the underside 7 of the essentially rectangular-solid-shaped base body 2. The two recesses 5a, 5b particularly preferably extend in the viewing direction D which can in turn extend perpendicularly with respect to the upper side 6 or the underside 7 of the base body 2.

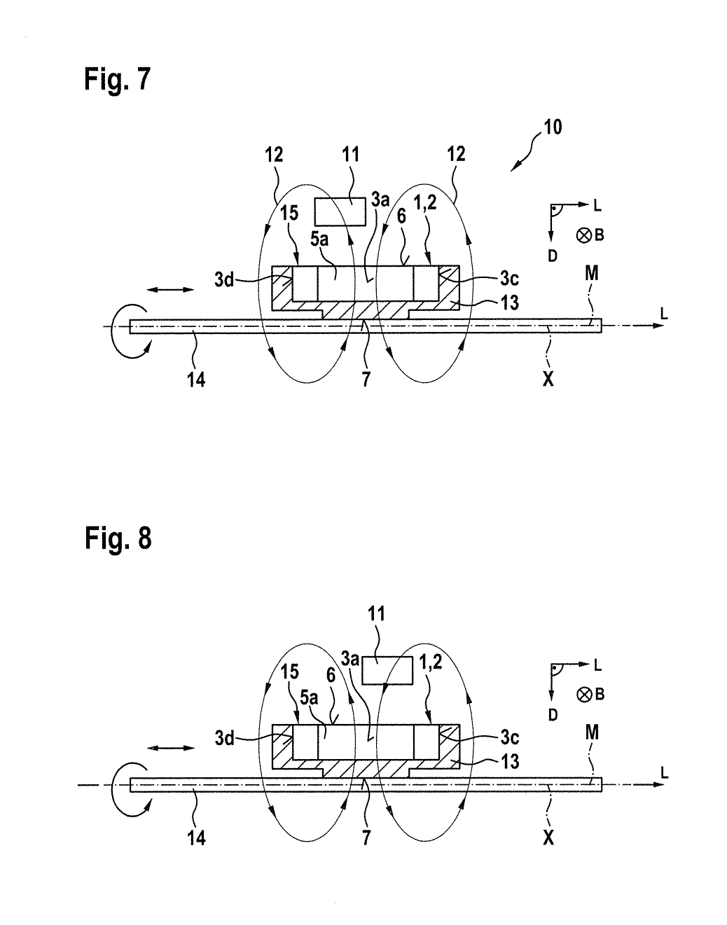

FIG. 7 shows a schematic illustration of the design of the magnetic field sensor arrangement 10 according to the invention with a magnetic element 1 as explained above, according to FIGS. 2 and 4, that is to say with four recesses 5a-5d. The magnetic element arrangement 10 comprises a magnetic field sensor 11, arranged at a distance from the magnetic element 10, for determining a magnetic field 12 which acts on the magnetic field sensor 11 and is generated by the magnetic element 1. As is apparent from FIG. 7, the magnetic element 1 is attached in a rotationally fixed fashion to a shaft 14 by means of an attachment device 13. The attachment device 13 can comprise a receptacle 15 in which the magnetic element 1 is at least partially accommodated. The attachment device 13 can be integrally formed on the shaft 14 or can be a separate component which is attached to the shaft 14, for example, by means of a bonded connection or screwed connection. A rotational axis X of the magnetic field sensor arrangement 10 is defined by a direction L of the longitudinal extent of the shaft 14, in particular by the centre longitudinal axis M thereof. The shaft 14 is embodied so as to be adjustable relative to the magnetic field sensor 11, in a rotatable fashion about the rotational axis X and in a translational fashion in the direction L of longitudinal extent. FIG. 7 shows the magnetic field arrangement 10 in a viewing direction B perpendicular both to the direction D perpendicular to the upper side of the FIGS. 1 and 4 and also to the direction L of longitudinal extent of the shaft 14. In other words, both the direction D and the direction L of longitudinal extent lie in the plane of the drawing in FIG. 7.

In the magnetic field sensor arrangement 10 according to the invention, the rotational axis X then runs in the plan view in the viewing direction D on the magnetic element 1 parallel or orthogonal to the first side 3a. For the sake of clarity, reference is made here to the sectional illustration according to FIG. 1 in which the shaft 14 is additionally shown for the sake of clarity of the possible arrangement of the shaft 14 and magnetic element 1 relative to one another. In the example in FIGS. 1 and 3, the shaft 14 of the magnetic field sensor arrangement 10 can run either parallel to the first side 3a or orthogonal to the first side 3a. The latter case is represented in the FIGS. 1 and 3 by a shaft 14′ denoted by 14′.

FIG. 8 shows the magnetic field sensor arrangement 10 in FIG. 7 with a shaft 14 which is adjusted in a translational fashion with respect to FIG. 7, in the direction L of longitudinal extent. This means that the attachment device 13 and therefore also the magnetic element 1 are offset with respect to the magnetic field sensor 11 in the direction L of longitudinal extent. As can be seen in FIGS. 7 and 8, such a translational adjustment of the magnetic element 1 relative to the magnetic field sensor 1 leads to a situation in which the magnetic field 12 which is generated by the magnetic element 1 impinges on the magnetic field sensor 11 from a changed direction. In other words, the translational movement of the magnetic element 1 relative to the magnetic field sensor 11 is converted into a change of angle of the magnetic field 12. By using the magnetic element 1 according to the invention it is possible here to achieve a particularly accurate angular resolution and therefore a particularly high level of accuracy when measuring the translational adjustment of the magnetic element 1 and the shaft 14.

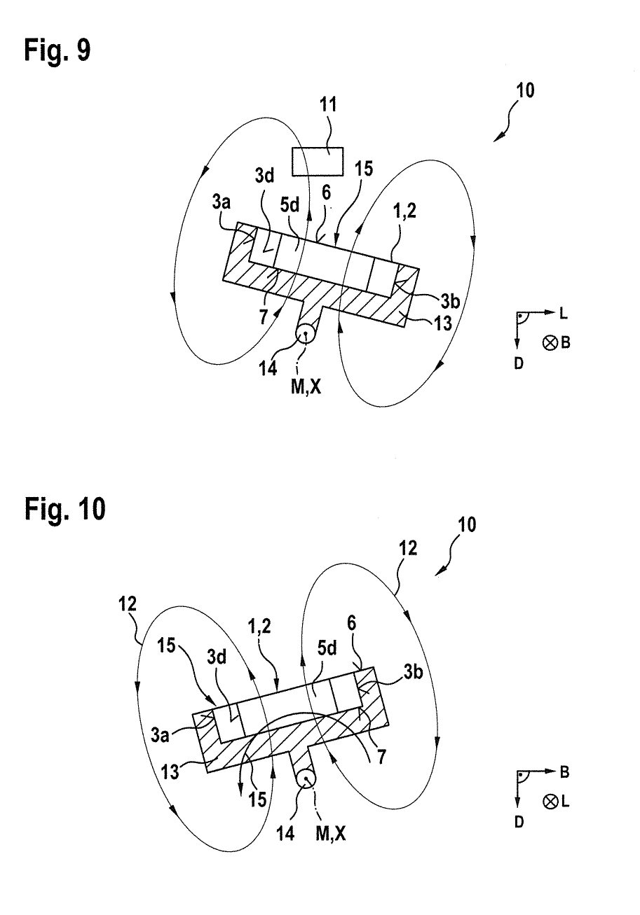

FIG. 9 shows the magnetic field sensor arrangement 10 in FIG. 7 in a viewing direction of the direction L of longitudinal extent, i.e. the direction B and the direction D are both arranged in the plane of the drawing. For the sake of clarity of the arrangement of the magnetic element 1, the attachment device 13 is illustrated opened toward the viewer in the viewing direction B. The attachment device 13 included in the receptacle 15 is to be understood in the example in the figures as being in any case only a rough schematic representation of a wide variety of structural forms of implementation. In this view, the fourth side 3d can be seen with the fourth recess 5d. FIG. 10 shows the magnetic field sensor arrangement 10 in FIG. 9 with a shaft 14 which is rotated with respect to FIG. 9 (cf. arrow 15 in FIG. 10).

As can be seen in FIGS. 9 and 10, a rotational adjustment of the magnetic element 1 relative to the magnetic field sensor 1 also leads to a situation in which the magnetic field 12 which is generated by the magnetic element 1 impinges on the magnetic field sensor from a changed direction. In other words, the rotational movement of the shaft 14 and therefore of the magnetic element 1 relative to the magnetic field sensor 11 is converted into a change of angle of the magnetic field 12. By using a magnetic element 1 according to the invention it is possible here to achieve a particularly accurate angular resolution and therefore a particularly high level of accuracy when measuring the rotational adjustment of the shaft 14 and of the magnetic element 1.

What is claimed is:

1. A magnetic element (1), comprising:
a base body (2) made of a magnetic or magnetizable material,
wherein the base body (2) has, in cross section, essentially the geometry of a rectangle (4) with a first side (3a) and a second side (3b) lying opposite the first side (3a), and
wherein in cross section the first side (3a) has a first recess (5a), and the second side (3b) has a second recess (5b).

2. The magnetic element of claim 1, wherein
the rectangle (4) has a third side (3c) and a fourth side (3d) lying opposite the third side (3c), which third and fourth sides (3c, 3d) connect the first side (3a) to the second side (3b) and in this way complete the first side (3a) and the second side (3b) to form the rectangle (4),
wherein in the third side (3c) there is a third recess (5c), and in the fourth side (3d) there is a fourth recess (5d), or
wherein there are no recesses in the third and fourth sides (3c, 3d).

3. The magnetic element of claim 1, wherein
at least one of the recesses (5a-5d) has a round contour in cross section.

4. The magnetic element of claim 1, wherein
at least one of the recesses (5a-5d) has a contour of an ellipsoidal segment in cross section.

5. The magnetic element of claim 1, wherein
at least two of the recesses (5a-5d) lying opposite one another are essentially identical.

6. The magnetic element of claim 1, wherein
at least one of the recesses (5a-5d) has a nonround geometry in cross section, with at least one corner (8).

7. The magnetic element of claim 1, wherein
in cross section a length (l) of at least one of the recesses (5a-5d) comprises at least a fifth of a length (l0) of the respective side (3a-3d) in which this recess (5a-5d) is formed.

8. The magnetic element of claim 1, wherein
in cross section, a length (l) of at least one of the recesses (5a-5d) comprises at maximum 90% of a length (l0) of the respective side (3a-3d) in which this recess (5a-5d) is formed.

9. The magnetic element of claim 1, wherein
the first side (3a) and the second side (3b) each connect an upper side (6) to an underside (7) of the base body (2), and
wherein the first recess (5a) in the first side (3a) extends from the upper side (6) as far as the underside (7), and the second recess (5b) in the second side (3b) extends from the upper side (6) as far as the underside (7).

10. The magnetic element of claim 1, wherein
the cross section is arranged parallel to a plan view of an upper side or underside (6, 7) of the base body (2).

11. The magnetic element of claim 1, wherein
the base body (2) of the magnetic element (1) is bipolar.

12. A magnetic field sensor arrangement (10), comprising:
a magnetic field sensor (11) arranged at a distance from the magnetic element (1) and configured for determining a magnetic field (12) that acts on the magnetic field sensor (11), and
the magnetic element (1) of claim 1 for generating the magnetic field (12), wherein
the magnetic element (1) is arranged in a rotationally fixed fashion on a shaft (14) by means of an attachment device (13), a rotational axis (X) of the magnetic field sensor arrangement (10) being defined by a direction (L) of a longitudinal axis of said shaft (14),
the shaft (14) is adjustable relative to the magnetic field sensor (11), in a rotatable fashion about the rotational axis (X) and/or in a translational fashion in the direction (L) of the axis, and
the rotational axis (X) runs in the cross section of the magnetic element (1), parallel or orthogonal to the first side (3a).

13. The magnetic field sensor arrangement of claim 12, wherein
the attachment device (13) comprises a receptacle (15) in which the magnetic element (1) is at least partially accommodated.

14. The magnetic field sensor arrangement of claim 12, wherein
the attachment device (13) is formed integrally formed on the shaft (14).
